(19) United States
(12) Patent Application Publication
(10) Pub. No.: US 2007/0280200 A1
(43) Pub. Date: Dec. 6, 2007

(54) SYSTEM AND METHOD FOR CONTROLLING A VOIP CLIENT USING A WIRELESS PERSONAL-AREA-NETWORK ENABLED DEVICE

(76) Inventor: Mehul B. Patel, Bangalore (IN)

Correspondence Address: KYOCERA WIRELESS CORP., P.O. BOX 928289, SAN DIEGO, CA, 92192-8289, US

(21) Appl. No.: 11/421,274

(22) Filed: May 31, 2006

(51) Int. Cl. H04L 12/66

(52) U.S. Cl. 370/352

(57) ABSTRACT

Systems and methods for seamless VOIP calling from a wireless communication device communicatively coupled with a VOIP enabled computer device over a personal area network connection, such as a Bluetooth link, are disclosed. The wireless communication device establishes a Bluetooth link with a VOIP enabled computer device and controls a VOIP call module on the VOIP enabled computer device. The VOIP enabled computer device registers the phone number of the wireless communication device with a network based VOIP server and subsequent VOIP calls are routed to the VOIP enabled computer device. Additionally, VOIP calls may be initiated by the wireless communication device. The VOIP enabled computer device processes these incoming or outgoing VOIP calls accordingly, sending audio out data over the Bluetooth link to the wireless communication device and receiving audio in data over the Bluetooth link from the wireless communication device.

### FIELD OF THE INVENTION

The present invention generally relates to wireless communication devices and more particularly relates to enabling voice over internet protocol (“VOIP”) calling through a wireless personal area network (PAN) link between a wireless communication device and a VOIP enabled computer device.

### BACKGROUND OF THE INVENTION

Conventional wireless communication devices that are Bluetooth enabled typically have the ability to communicate with computer devices that are also Bluetooth enabled. However, although the two devices can interact, there is no link between the voice connection functionality of the wireless communication device and the VOIP functionality on the computer device.

A significant drawback of this lack of interactivity is that a user must separately make VOIP calls from the computer and wireless network calls from the wireless communication device. An additional drawback of the conventional devices is that the user is required to have two phone numbers, one for the VOIP interface and a second for the wireless communication device.

These significant drawbacks of the conventional wireless communication devices and VOIP enabled computer devices result in less than desirable communications for consumers who need the transparent capability to have a single phone number for use with both VOIP calls and wireless communication calls. Accordingly, what is needed is a system and method that overcomes these problems with the conventional solutions.

### SUMMARY OF THE INVENTION

Described herein are systems and methods for seamless VOIP calling from a wireless communication device communicatively coupled with a VOIP enabled computer device over a personal area network (PAN), such as a Bluetooth link. The wireless communication device establishes a Bluetooth link with a VOIP enabled computer device and then initiates control of a VOIP call module on the VOIP enabled computer device. The VOIP enabled computer device then updates its VOIP profile to reflect the parameters of the wireless communication device and then registers the phone number of the wireless communication device with a VOIP server. Subsequent VOIP calls are routed to the VOIP enabled computer device. The VOIP enabled computer device then processes the VOIP call accordingly, sending the audio out over the Bluetooth link to the wireless communication device and similarly receiving audio in over the Bluetooth link from the wireless communication device.

### BRIEF DESCRIPTION OF THE DRAWINGS

FIG. 1 is a block diagram illustrating an example system for controlling a VOIP client using a Bluetooth link from a wireless communication device according to an embodiment of the present invention.

FIG. 2 is a block diagram illustrating an example wireless communication device according to an embodiment of the present invention.

FIG. 3 is a block diagram illustrating an example VOIP enabled computer according to an embodiment of the present invention.

FIG. 4 is a flow diagram illustrating an example process for initializing a VOIP client via a Bluetooth link according to an embodiment of the present invention.

FIG. 5 is a flow diagram illustrating an example process for establishing a VOIP call via a Bluetooth link according to an embodiment of the present invention.

FIG. 6 is a flow diagram illustrating an example process for receiving an incoming VOIP call according to an embodiment of the present invention.

FIG. 7 is a block diagram illustrating an exemplary wireless communication device that may be used in connection with the various embodiments described herein.

FIG. 8 is a block diagram illustrating an exemplary computer system that may be used in connection with the various embodiments described herein.

### DETAILED DESCRIPTION

Certain embodiments as disclosed herein provide for systems and methods for controlling a VOIP client using a Bluetooth enabled device, although other auxiliary wireless communication networks, such as wireless personal area networks may also be used with the present invention for establishing communication between the VOIP client device and the handheld wireless communication device. For example, one method provides for a Bluetooth enabled wireless communication device having its own telephone number to send and receive VOIP calls through a companion VOIP enabled computer device. The wireless communication device connects to the VOIP enabled computer device through a Bluetooth link and updates the VOIP profiled of the VOIP enabled computer device to reflect the parameters of the wireless communication device. Thereafter the wireless communication device can place VOIP calls through the VOIP enabled computer device and receive VOIP calls in the same fashion.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

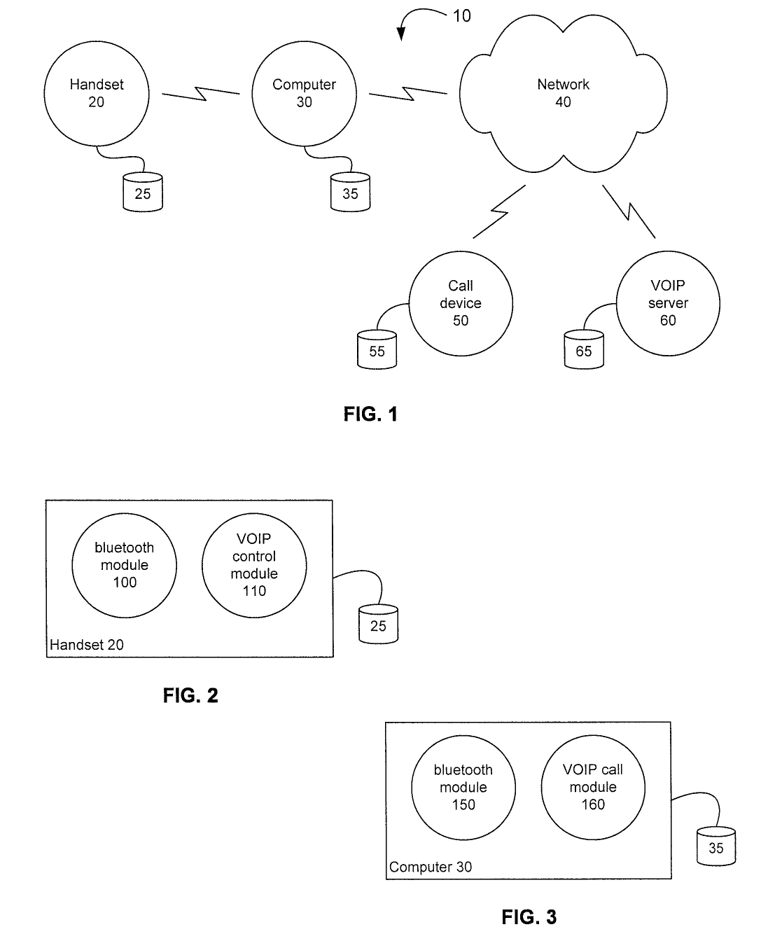

FIG. 1 is a block diagram illustrating an example system 10 for controlling a VOIP client using a Bluetooth link from a wireless communication device according to an embodiment of the present invention. In the illustrated embodiment, the system 10 comprises a wireless communication device 20 configured with a data storage area 25, a computer device 30 configured with a data storage area 35, a call device 50 configured with a data storage area 55, and a VOIP server 60 configured with a data storage area 65. The call device 50 and VOIP server 60 are communicatively coupled with the computer 30 via a network 40.

The wireless communication device 20 can be any of a variety of wireless communication devices, including a cell phone, personal digital assistant (“PDA”), personal computer (“PC”), laptop computer, PC card, special purpose equipment, or any combination of these and other devices capable of establishing a Bluetooth wireless communication link with the computer 30. In the certain embodiments of the present invention, wireless communication device 20 is configured as a “multi-mode” wireless communication devices capable of communication over a plurality of radio access technologies. In one particular embodiment, wireless communication device 20 is capable of communication over a wireless wide area network, such as cellular radio and is further capable of communication over a wireless personal area network, such as Bluetooth. An example general purpose wireless device is later described with respect to FIG. 7. The wireless communication device 20 may be referred to herein as a handset, wireless device, mobile device, device, wireless unit, or mobile unit.

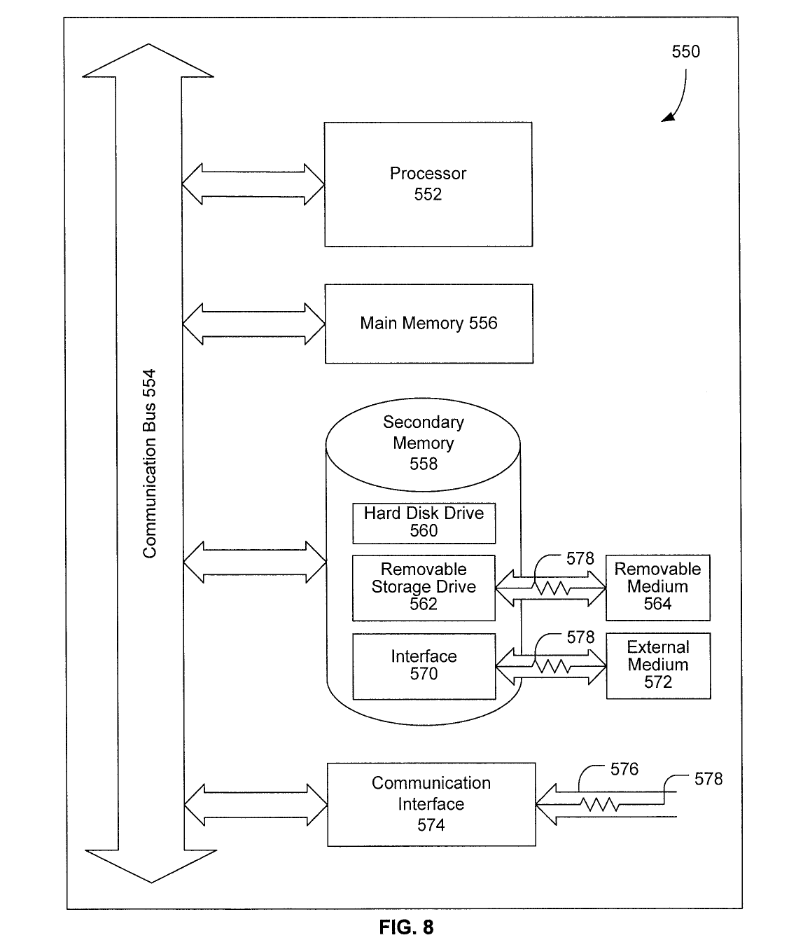

The computer 30 may any of a variety of computer devices that are configured for communication over network 40. An example general purpose computer device is later described with respect to FIG. 8. The computer 30 is also configured with a data storage area 35.

The call device 50 can be any of a variety of devices that are capable of establishing a VOIP call. For example, the device 50 may be a VOIP phone, a general purpose computer with VOIP hardware and/or software modules, or an analog telephone adaptor coupled with a conventional analog phone, just to name a few. Other types of call devices 50 will be well understood by those having skill in the art having the benefit of the present disclosure. The call device 50 is also configured with a data storage area 55.

The VOIP server 60 can be any of a variety of devices that are capable of facilitating a VOIP call. In one embodiment, the VOIP server 60 may be a call processor server that employs a database or other type of mapping program call a soft switch that maps phone numbers to internet protocol (“IP”) addresses. For example, the VOIP server 60 may receive a telephone number when a VOIP call connection is requested and then lookup the current IP address associated with the telephone number. The VOIP server 60 then provides the caller with the IP address of the intended recipient so the VIOP call may be established directly. The VOIP server 60 is also configured with a data storage area 65.

The data storage areas 25, 35, 55, and 65 that are associated with the various devices in FIG. 1 can be any sort of internal or external memory device and may include both persistent and volatile memories. The function of the data storage areas 25, 35, 55, and 65 is to maintain data for long term storage and also to provide efficient and fast access to instructions for applications that are executed by the respective device or module.

The network 40 may comprise a plurality of networks including private, public, circuit switched, packet switched, personal area networks (“PAN”), local area networks (“LAN”), wide area networks (“WAN”), metropolitan area networks (“MAN”), or any combination of these. Other network types may also be included as needed to facilitate communication between the computer 30 and the VOIP server 60 and the call device 50. For the sake of simplicity of this description, however, the embodiment described will employ a single network 40 that provides access for the computer 30 to communicate with the call device 50 and the VOIP server 60.

FIG. 2 is a block diagram illustrating an example wireless communication device 20 according to an embodiment of the present invention. In the illustrated embodiment, the handset 20 comprises a Bluetooth module 100 and a VOIP control module 110. The handset 20 also is configured with a data storage area 25.

The Bluetooth module 100 is configured to establish a Bluetooth link with another Bluetooth enabled device. Specifically, the Bluetooth module is configured to establish a direct wireless connection with a VOIP enabled device so that the handset 20 can initiate and receive VOIP calls.

The VOIP control module 110 is configured to manage the sending and receiving of VOIP calls on the handset 20. In one embodiment, the VOIP module is configured to work cooperatively with a VOIP enabled device to establish send and receive channels to carry incoming and outgoing VOIP call traffic for VOIP calls that are made through the VOIP enabled device.

FIG. 3 is a block diagram illustrating an example VOIP enabled computer 30 according to an embodiment of the present invention. In the illustrated embodiment, the VIOP enabled computer 30 comprises a Bluetooth module 150 and a VOIP call module 160. The computer 30 is also configured with a data storage area 35. The Bluetooth module 150 is configured to establish a Bluetooth link with another Bluetooth enabled device such as the handset 20. In one embodiment, once the Bluetooth module establishes a Bluetooth link, any sort of data traffic may be sent and received over the Bluetooth link, for example, incoming and outgoing VOIP call traffic for VOIP calls that are made through the computer 30.

The VOIP call module 160 is configured to establish and maintain VOIP calls, whether originated at the computer 30 or by a remote calling device. In one embodiment, the VOIP call module 160 is configured to work cooperatively with a VOIP control module on a handset to establish channels for incoming and outgoing VOIP call traffic. Additionally, the VOIP call module 160 can be configured to be under the operative control of a VOIP control module such that the user can access all VOIP features and functionality through the handset that is running the VOIP control module.

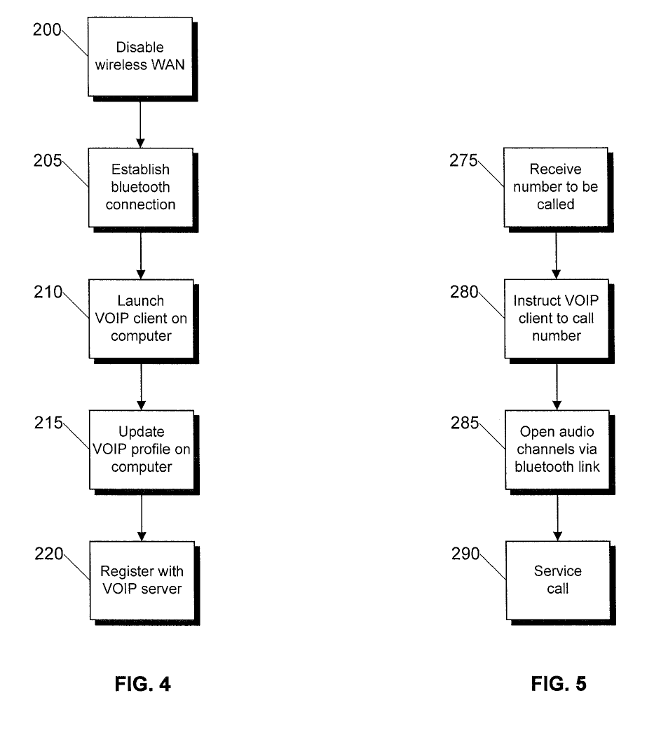

FIG. 4 is a flow diagram illustrating an example process for initializing a VOIP client via a Bluetooth link according to an embodiment of the present invention. In one embodiment, the process may be carried out, for example, by a handset such as the handset previously described with respect to FIG. 1. The steps as presented may also be employed in a different order or in the order as presented. Initially, in step 200 the handset may disable its wireless WAN radio and/or antenna systems. Advantageously, this may preserve the battery power of the handset while it is in VOIP mode. As part of disabling the antenna and/or radio systems, but prior to the shut down, the handset may update a home location register (“HLR”) on the WAN to inform the wireless WAN network (e.g., cellular network) and future callers that the handset may be reached at a particular IP address, or to instruct callers seeking information about the handset from the HLR to inquiry with the VOIP server. In certain embodiments, this step may be carried out later in the process, for example, after the handset is registered with the VOIP server.

Next, in step 205 the handset establishes a direct wireless link with the VOIP enabled computer device. As illustrated in the figure, the wireless link can be a wireless PAN link, such as Bluetooth, however other direct wireless links may also be employed. Once the connection is established, in step 210 the handset can instruct the VOIP enabled computer device to launch a VOIP client that is configured to establish VOIP calls. Additionally, in step 215 the handset provides the VOIP client on the computer with profile information for the handset so that calls to the handset number can be directed to the handset via a VOIP call. For example, the handset can provide the handset telephone number to the VOIP client on the computer and then the VOIP client can update its profile for the handset. Additional information in the profile for the handset may include parameters for the audio in and audio out channels over the Bluetooth link.

Once the VOIP client has the necessary information for the handset in its profile for the handset, the VOIP client registers the phone number with the VOIP server in step 220 so that future calls to the handset number are mapped to the current IP address of the VOIP enabled computer and then routed to the handset via the Bluetooth link.

FIG. 5 is a flow diagram illustrating an example process for establishing a VOIP call via a Bluetooth link according to an embodiment of the present invention. In one embodiment, the process may be carried out, for example, by a handset such as the handset previously described with respect to FIG. 1. The steps as presented may also be employed in a different order or in the order as presented. Initially, in step 275 the handset receives the number to be called. The number may be received from the user via the keypad, via audio input and voice recognition, or via a selection by the user of a number stored in the phone book on the handset. Alternative ways to provide the phone number to be dialed to the handset may also be employed.

Next, in step 280 the handset instructs the VOIP client on the companion VOIP enabled computer to call the particular number. Audio in and audio out channels are then established between the handset and the VOIP enable computer, as shown in step 285. The audio channels are established via the Bluetooth link. Once the audio channels have been established, service of the call takes place accordingly with audio out traveling from the handset to the VOIP enabled computer and with audio in traveling from the VOIP enabled computer to the handset. In this fashion, the analog audio in and out takes place at the handset and the conversion of the audio signals into VOIP call packets takes place at the VOIP enabled computer.

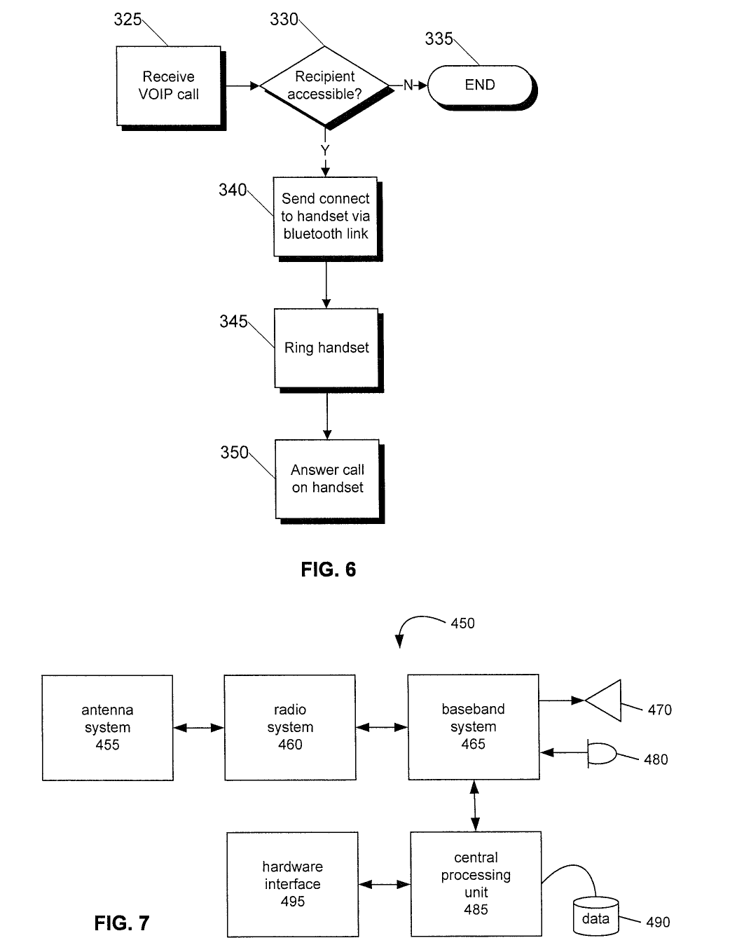

FIG. 6 is a flow diagram illustrating an example process for receiving an incoming VOIP call according to an embodiment of the present invention. In one embodiment, the process may be carried out, for example, by a VOIP enabled computer such as the computer previously described with respect to FIG. 1. Initially, in step 325 an incoming VOIP call is received by the VOIP enabled device. In one embodiment, the VOIP enabled device may process VOIP calls for multiple handset devices and for the computer itself and therefore multiple telephone numbers may resolve to the IP address of the VOIP enabled device at the VOIP server. As discussed above in conjunction with step 200 of FIG. 4, the handset may update an HLR on the WAN to inform the wireless WAN network (e.g., cellular network) and future callers that the handset may be reached at a particular IP address, or to instruct callers seeking information about the handset from the HLR to inquiry with the VOIP server. In this way, calls initially directed to the user's mobile phone number are routed to the VOIP server for processing over the method described according to FIG. 6.

Accordingly, the VOIP client may determine in step 330 that the intended recipient of the incoming VOIP call is a handset that is accessible via a direct wireless link. If the intended recipient is not accessible via a wireless link, then the process ends in step 335.

If, as determined in step 330, the call is for a handset device accessible via a direct wireless link, in step 340 the VOIP client sends a connect request to the handset via the direct wireless link. For example, the direct wireless link can be a Bluetooth connection. In one embodiment, the Bluetooth link may already be established between the handset and the VOIP enabled device and thus the connect request is just sent over the established link. Alternatively, if the Bluetooth link is not currently active, the VOIP client may initiate the Bluetooth link in order to connect with the handset for the call. Additionally, as part of establishing the connection between the VOIP enabled device and the handset, discrete audio in and audio out channels may be configured to handle the call traffic.

Once the connection is established, in step 345 the VOIP client may send an incoming call notification or instruction that causes the handset to ring. Alternative techniques for ringing the handset may also be employed. Once the handset has been instructed to ring, in step 350 the user answers the handset and the audio in and audio out channels are activated to carry the audio in and audio out traffic during the call. Advantageously, the conversion of the audio data from the handset to VOIP packet data can take place at the VOIP enabled device and be managed by the VOIP client.

FIG. 7 is a block diagram illustrating an exemplary wireless communication device 450 that may be used in connection with the various embodiments described herein. For example, the wireless communication device 450 may be used in conjunction with a handset, computer, or call device previously described with respect to FIG. 1. However, other wireless communication devices and/or architectures may also be used, as will be clear to those skilled in the art having the benefit of the present disclosure.

In the illustrated embodiment, wireless communication device 450 comprises an antenna system 455, a radio system 460, a baseband system 465, a speaker 464, a microphone 470, a central processing unit (“CPU”) 485, a data storage area 490, and a hardware interface 495. In the wireless communication device 450, radio frequency (“RF”) signals are transmitted and received over the air by the antenna system 455 under the management of the radio system 460.

In one embodiment, the antenna system 455 may comprise one or more antennae and one or more multiplexors (not shown) that perform a switching function to provide the antenna system 455 with transmit and receive signal paths. In the receive path, received RF signals can be coupled from a multiplexor to a low noise amplifier (not shown) that amplifies the received RF signal and sends the amplified signal to the radio system 460.

In alternative embodiments, the radio system 460 may comprise one or more radios that are configured to communication over various frequencies. In one embodiment, the radio system 460 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 460 to the baseband system 465.

If the received signal contains audio information, then baseband system 465 decodes the signal and converts it to an analog signal. Then the signal is amplified and sent to the speaker 470. The baseband system 465 also receives analog audio signals from the microphone 480. These analog audio signals are converted to digital signals and encoded by the baseband system 465. The baseband system 465 also codes the digital signals for transmission and generates a baseband transmit audio signal that is routed to the modulator portion of the radio system 460. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 455 where the signal is switched to the antenna port for transmission.

The baseband system 465 is also communicatively coupled with the central processing unit 485. The central processing unit 485 has access to a data storage area 490. The central processing unit 485 is preferably configured to execute instructions (i.e., computer programs or software) that can be stored in the data storage area 490. Computer programs can also be received from the baseband processor 465 and stored in the data storage area 490 or executed upon receipt. Such computer programs, when executed, enable the wireless communication device 450 to perform the various functions of the present invention as previously described. For example, data storage area 490 may include various software modules (not shown) that were previously described with respect to FIGS. 2 and 3.

In this description, the term “computer readable medium” is used to refer to any media used to provide executable instructions (e.g., software and computer programs) to the wireless communication device 450 for execution by the central processing unit 485. Examples of these media include the data storage area 490, microphone 470 (via the baseband system 465), antenna system 455 (also via the baseband system 465), and hardware interface 495. These computer readable mediums are means for providing executable code, programming instructions, and software to the wireless communication device 450. The executable code, programming instructions, and software, when executed by the central processing unit 485, preferably cause the central processing unit 485 to perform the inventive features and functions previously described herein.

The central processing unit 485 is also preferably configured to receive notifications from the hardware interface 495 when new devices are detected by the hardware interface. Hardware interface 495 can be a combination electromechanical detector with controlling software that communicates with the CPU 485 and interacts with new devices. The hardware interface 495 may be a firewire port, a USB port, a Bluetooth or infrared wireless unit, or any of a variety of wired or wireless access mechanisms. Examples of hardware that may be linked with the device 450 include data storage devices, computing devices, headphones, microphones, and the like.

FIG. 8 is a block diagram illustrating an exemplary computer system 550 that may be used in connection with the various embodiments described herein. For example, the computer system 550 may be used in conjunction with a computer, VOIP server, or call device previously described with respect to FIG. 1. However, other computer systems and/or architectures may be used, as will be clear to those skilled in the art having the benefit of the present disclosure.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art having the benefit of the present disclosure. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A computer implemented method for controlling a communication client on a computer from a multi-mode wireless communication device registered on a communication server using a first radio access technology radio, the method comprising:
detecting the presence of the computer within a range of the multi-mode wireless communication device;
establishing communications between the computer and the multi-mode wireless communication device using a second radio access technology radio;
launching the communication client on the computer; and
registering the communication client on the communication server such that calls directed to a phone number associated with the wireless communication device are routed to the communication client.

2. The method of claim 1, further comprising disabling the first radio access technology radio on the wireless communication device.

3. The method of claim 2, further comprising establishing a call with the wireless communication device using the second radio access technology radio.

4. The method of claim 2, further comprising updating a home location register on the communication server prior to disabling the first radio access technology radio.

5. The method of claim 4, wherein updating the home location register comprises providing an internet protocol address associated with the communication client.

6. A computer implemented method for enabling voice over internet protocol (VOIP) calls on a multi-mode wireless communication device communicatively coupled with a VOIP enabled device via a Bluetooth link, comprising:
establishing a Bluetooth link between a wireless communication device and a VOIP enabled device;
providing a set of VOIP parameters to the VOIP enabled device via the Bluetooth link, the set of VOIP parameters comprising a phone number for the wireless communication device;
instructing the VOIP enabled device to update a VOIP profile with the VOIP parameters; and
instructing the VOIP enabled device to register the phone number for the wireless communication device with a VOIP server.

7. The method of claim 6, further comprising:
receiving at the VOIP enabled device an incoming VOIP call destined for the phone number of the wireless communication device;
establishing an audio channel with the wireless communication device via the Bluetooth link; and
sending and receiving audio data to and from the wireless communication device via the Bluetooth link to manage the VOIP call.

8. The method of claim 6, wherein the multi-mode communication device comprises a first radio access technology radio and a second radio access technology radio, the method further comprising disabling the first radio access technology radio.

9. The method of claim 8, further comprising updating a home location register associated with a communication server accessible via the first radio access technology radio prior to disabling the first radio access technology radio.

10. The method of claim 9, wherein updating the home location register comprises providing an internet protocol address associated with the communication client.

11. A system for enabling voice over internet protocol (VOIP) calls on a multi-mode wireless communication device communicatively coupled with a VOIP enabled device via a Bluetooth link, comprising:
a multi-mode wireless communication device having a first radio access technology radio, a second radio access technology radio, a first Bluetooth module, and a VOIP control module;
a VOIP enabled device having a second radio access technology radio, a second Bluetooth module and a VOIP call module;
wherein the first and second Bluetooth modules are configured to establish a Bluetooth communication link via the respective second radio access technology radios and the VOIP control module is configured to control the VOIP call module to place a VOIP call.

12. The system of claim 11, wherein the VOIP call module is configured to route an incoming VOIP call destined for the wireless communication device to the VOIP control module.

13. The system of claim 11, wherein the wireless communication device is configured to disable the first radio access technology radio.

14. The system of claim 13, wherein the first radio access technology radio is disabled after the Bluetooth communication link is established.

15. The system of claim 13, wherein the wireless communication device is further configured to update a home location register associated with a communication server accessible via the first radio access technology radio prior to disabling the first radio access technology radio.

16. The system of claim 15, wherein updating the home location register comprises providing an internet protocol address associated with the communication client.

17. A multi-mode wireless communication device comprising:
a first radio access technology radio configured to establish a call over a wireless communication network;
a second radio access technology radio configured to establish a direct communication link over a second radio access technology radio;
a control module configured to establish communication with a remote voice over internet protocol call (VOIP) call module via the second radio access technology radio and establish a VOIP call via the VOIP call module over the second radio access technology radio.

18. The wireless communication device of claim 17, wherein the VOIP call module is configured to route an incoming VOIP call destined for the wireless communication device to the VOIP control module over the second radio access technology radio.

19. The wireless communication device of claim 17, wherein the wireless communication device is configured to disable the first radio access technology radio.

20. The wireless communication device of claim 19, wherein the first radio access technology radio is disabled after communication with the remote VOIP call module is established via the second radio access technology radio.

21. The wireless communication device of claim 19, wherein the wireless communication device is further configured to update a home location register associated with a communication server accessible via the first radio access technology radio prior to disabling the first radio access technology radio.

22. The wireless communication device of claim 21, wherein updating the home location register comprises providing an internet protocol address associated with the communication client.
